(19) United States
(12) Patent Application Publication
(10) Pub. No.: US 2012/0224318 A1
(43) Pub. Date: Sep. 6, 2012

(54) Tablet computer holder

(76) Inventor: Raymond Blake Carleton, Henrico County, VA (US)

(21) Appl. No.: 13/385,712

(22) Filed: Mar. 3, 2012

Related U.S. Application Data
(60) Provisional application No. 61/464,457, filed on Mar. 4, 2011.

(51) Int. Cl. A45F 5/00; G06F 1/16; B65D 69/00

(52) U.S. Cl. 361/679.26; 206/576; 294/165

(57) ABSTRACT

A holder for a tablet computer attaches to the computer and may be grasped and held by one or two human users operating the computer or looking at its display screen. The holder is a substantially flat, rigid, frame-like, rectangular panel having two opposite generally concave short sides, two opposite generally concave long sides, and four convex lobes at the “corners”. Elongated slots near the short sides serve as finger- and thumb-holes and define flat handles. The computer screen is viewed through a large rectangular central opening in the panel.

### CROSS-REFERENCE TO RELATED APPLICATIONS

This application discloses and claims subject matter which was disclosed in copending provisional patent application Ser. No. 61/464,457 filed Mar. 4, 2011 and titled “Tablet Computer Holder”.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### SEQUENCE LISTING

Not applicable.

### BACKGROUND OF THE INVENTION

1. Field of the Invention

The invention pertains to tablet computer holders which may be grasped and held by a human operating the computer or looking at its display screen. Examples of tablet computers are Apple iPads, Motorola Xoom Tablets, Samsung Galaxy Tabs, and Huawei Ideos Tablets.

2. Description of Related Art

While in most cases the slogan “smaller is better” applies to computers of a given screen size, there are situations in which it does not. In those situations, it may be advantageous to attach devices to the computer to make it easier to handle, operate, store, retrieve, or protect. It is also known that computers may have handles and the like built into them. See, for example, Clementson et al. U.S. Pat. No. 6,000,665, Support Device and Method for Use with a Miniature Electronic Device; Swindler et al. U.S. Pat. No. 6,028,765, Removable Hand-Grips for a Portable Pen-Based Computer; Kim et al. U.S. Pat. No. 6,101,086, Portable Computer with Hand Grip; Lautner U.S. Pat. No. 6,726,070, Ergonomic Input-Device Holder; Jones et al, U.S. Pat. No. 7,428,143, Tablet Computer Palette with Extended Bezel; Holland, U.S. Pat. D495,369, Clipboard; and Mak, U.S. Pat. D591,801, Toy Drawing Board. These solutions tend to be complex, bulky, non-versatile, and expensive.

There are also frame-like enclosures for computers available for sale on the internet. Some of these are also complex, bulky, non-versatile, and expensive, e.g., AMDI iAdaper case. Others are merely intended to protect the computer and/or to provide a carrying handle like an attaché case handle, e.g. M-Edge, AddyCase, Laugh & Learn apptivity Case, Colorware Grip. Most of them are designed for use by babies or young children, rather than for productivity.

### BRIEF SUMMARY OF THE INVENTION

This invention comprises a holder attachable to a tablet computer. It is essentially a flat, rigid, frame-like, rectangular panel having elongated, handle-defining slots near, and generally parallel to, its short sides. These sides, and preferably at least one of the long sides, are curved inward at the center to form a large concave arc. The “corners” are curved to form lobes which terminate in convex arcs.

My invention addresses situations in which a primary user, who typically is the owner or custodian of the tablet computer and its contents, wishes to physically share the information with a secondary user by allowing him or her to view the screen, input information to the computer, or manipulate the computer to get information out of it. I refer to these as “sharing situations”. I made this invention for use in administration of physical fitness programs, but it should have applications in other situations as well, particularly those involving supplier and customer relationships. Examples of secondary users are clients, customers, prospects, and students. Examples of primary users are estimators, automobile service managers, retail sales personnel, and teachers. As used herein, “user” and usee” will be synonymous with primary user and secondary user, respectively.

Currently it is tedious for a primary user of a tablet computer to show the screen to a secondary user. The edge bordering the screen is so small that it is difficult to grasp, and it is easy to inadvertently activate the touch feature. This makes it awkward to show or pass the computer to the secondary user. Also, even when such a mishap is avoided, the care that must be taken is distracting, and the resulting body language implies that the information on the screen is not legitimately at the disposal of the secondary user, but rather is being made available at the sufferance of, and with inconvenience to, the primary user. The secondary user may see himself or herself as being treated like an onlooker or a voyeur, rather than a partner with whom useful information is being shared. This may lead him or her to adopt a “Whatever you say” attitude, rather than a positive spirit of confirmation and contribution.

If compactness and portability are not at a premium, the invention may also be useful in non-sharing situations (i.e., where there is no secondary user), due to its advantages in handling, operation, storage, retrieval, or protection, as mentioned above with respect to related art.

### BRIEF DESCRIPTION OF THE SEVERAL VIEWS OF THE DRAWING

FIG. 1 is a plan view of a holder according to the invention.

FIG. 2 is a side view of the holder shown in FIG. 1.

FIG. 3 is section of FIG. 1 taken at 3-3.

FIG. 4 is section of FIG. 1 taken at 4-4.

FIG. 5 is a plan view of the holder showing in broken lines a clamshell-like enclosure for the tablet. The top of the enclosure is attached to the bottom of the holder.

FIG. 6 is a section of FIG. 5 taken at 6-6.

FIG. 7 is a fragmentary enlargement of the holder at the left side of FIG. 6.

FIGS. 8-13 show six different positions for holding the holder and attached tablet.

The drawings show the tool and the tray approximately to scale, except that thicknesses of thin components may be exaggerated for clarity.

### DETAILED DESCRIPTION OF THE INVENTION

The present invention allows the computer to be held in a number of new positions. The primary user will usually be the owner or custodian of the holder and computer who is initially referring to information on the computer, while the secondary user will be a person who is receiving the information. These descriptions will assume that the primary user is right handed, but it will be understood that they will apply symmetrically to a left handed primary user, mutatis mutandis.

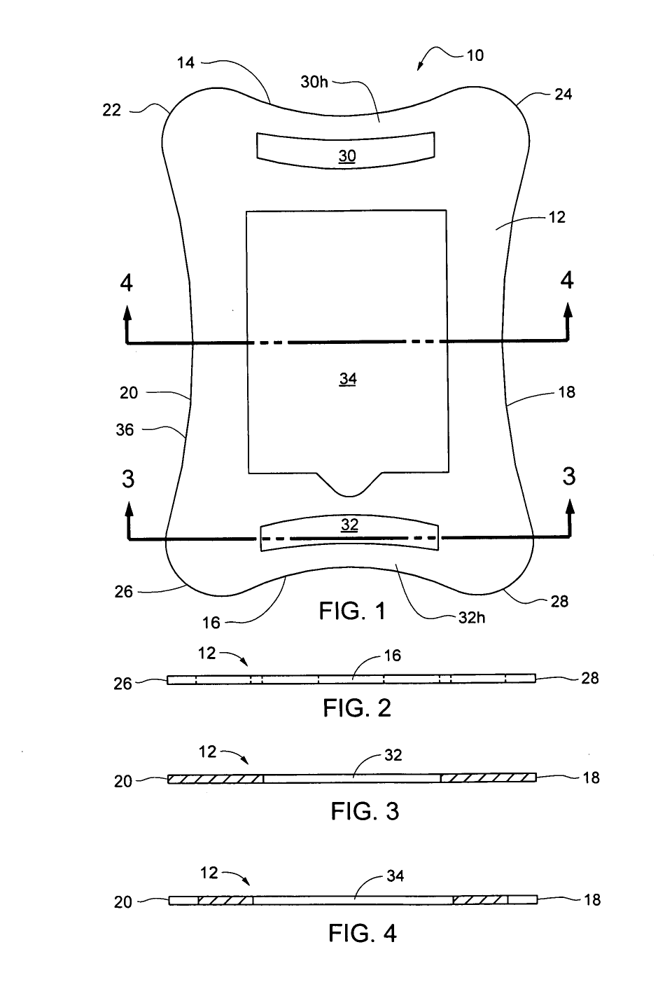

As mentioned above and shown in FIGS. 1-7, holder 10 is substantially flat, rigid, frame-like, rectangular panel 12 having two generally concave short sides 14, 16, two generally concave long sides 18, 20, and four rounded corners or lobes 22, 24, 26, 28. Elongated, curved slots 30, 32 near the shorter sides serve as finger- or thumb-holes and define handles 30h and 32h. Large rectangular center opening 34 is approximately the size of the computer screen. On one side, the opening has a V-shaped notch 36 for facilitating the detachment of the computer.

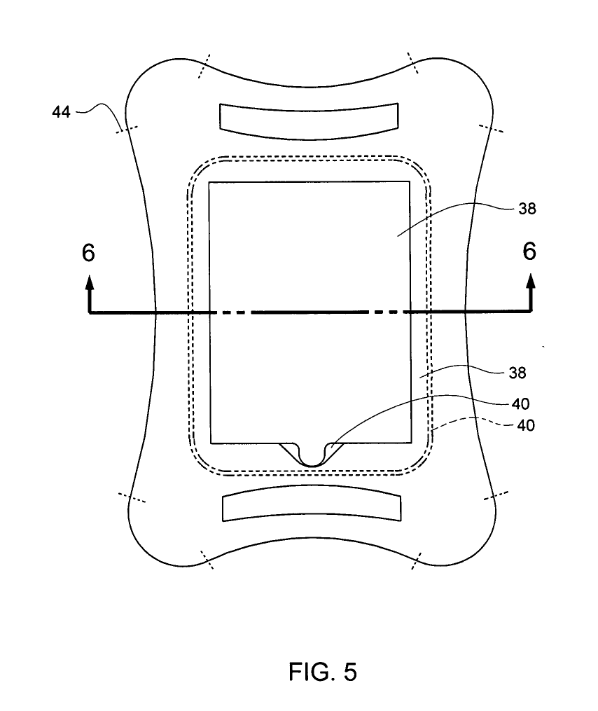

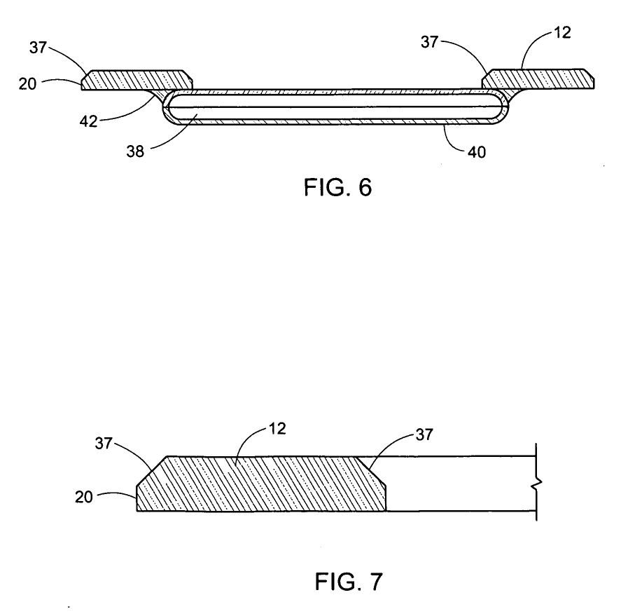

As shown in FIGS. 5 and 6, the upward facing edges of panel 12 are chamfered, as shown at 37, or radiused, and the computer 38 is in a separate enclosure or clamshell 40. The top surface of the clamshell is glued to the corresponding bottom surface of the panel by adhesive 42. FIG. 5 also shows hash marks 44, which indicate the intersections of the concave and convex arcs defining the peripheral edge of panel 12.

An example of such an enclosure is the Apple iPad Crystal Design Case—Clear, which is sold by Luxmo as CAIDCL and depicted at www.luxmo.com. This enclosure consists of two parts—a bottom part and a top part. The bottom part is solid. The top part is essentially a frame whose open portion is approximately the same size as the screen of the computer and the corresponding opening in the holder. Thus, the clamshell does not interfere with viewing or operating the computer's touch screen. Its two parts have slightly resilient side walls with small horizontal ridges and valleys that mate with each other, so that the two parts snap together so as to closely fit the computer.

While FIGS. 5 and 6 show the top surface of the computer glued to the top surface of the clamshell, it will be understood that conceptually the top surface of the computer might just as well be glued directly to the top surface of the panel, so as to dispense with the clamshell entirely. The clamshell allows the computer to be removed from and re-inserted as desired. It also avoids marring the surface of the computer. Alternatively, the top surface of the computer may be mechanically attached to the top surface of the panel, preferably in a secure manner that permits easy disconnection and reconnection, as for example by screws or other fasteners.

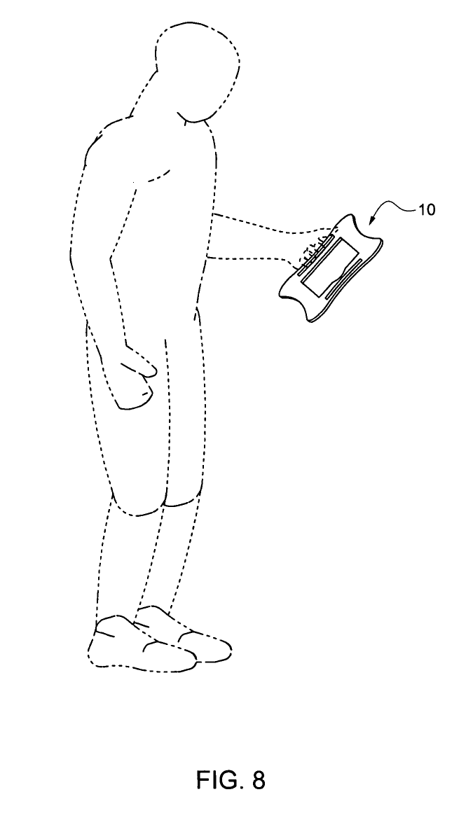

In FIG. 8, the primary user holds the holder with only his or her left hand, which is at 9 o'clock, with the long sides of the panel extending horizontally outward. The user's fingers pass around the outside edge of the handle, hook under it, and pass upward through the slot. The grip is similar to one's natural grip on a steering wheel. The user's thumb is bearing down on the panel at a location corresponding to lobe 26 in FIG. 1, which resists the tendency of the holder to rotate downward about the axis of the handle. If the user has smaller hands, the thumb will bear on the flat handle near the lobe.

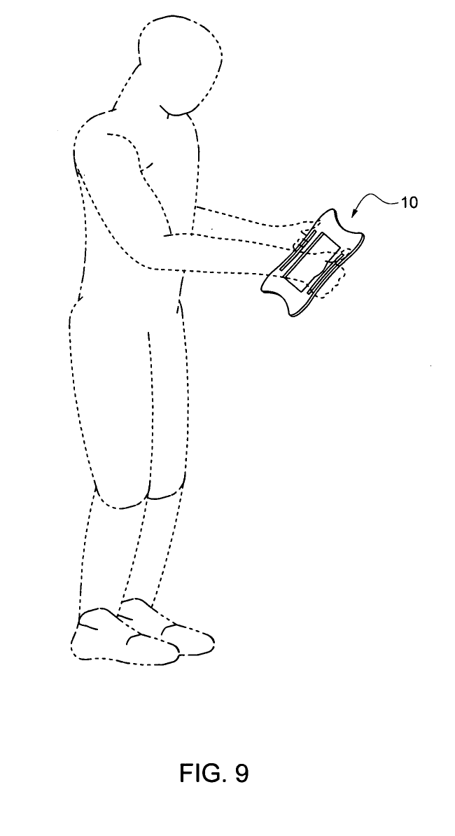

In FIG. 9, the primary user holds the holder with both hands, at 9 o'clock and 3 o'clock.

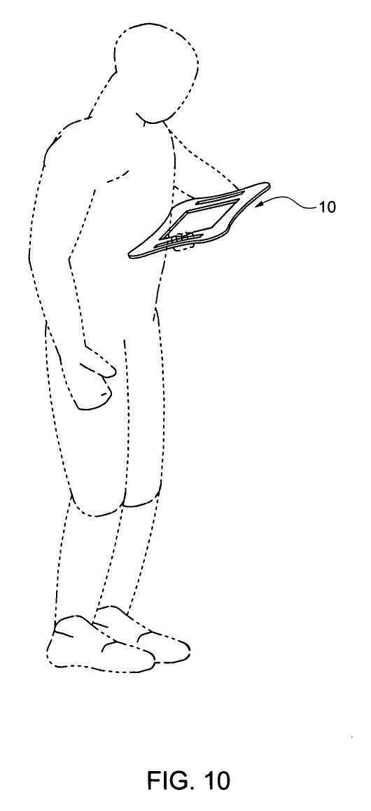

In FIG. 10, the primary user holds the holder with his or her left forearm under the holder, with the fingers of the left hand extending through the right finger hole from the bottom. The left side of the holder is cradled between the left forearm and the left upper arm (i.e., at the elbow), while the bottom of the holder is held against his/her midsection, where the concavity and lobes keep it stable and secure.

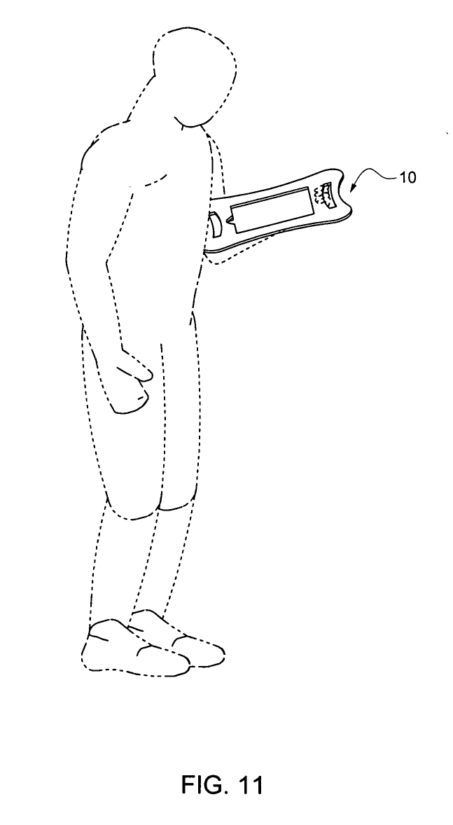

In FIG. 11, the position is similar to that of FIG. 10, but the holder is pivoted 90 degrees counterclockwise, so that left side of the holder is held against the primary user's midsection, rather than at the elbow joint.

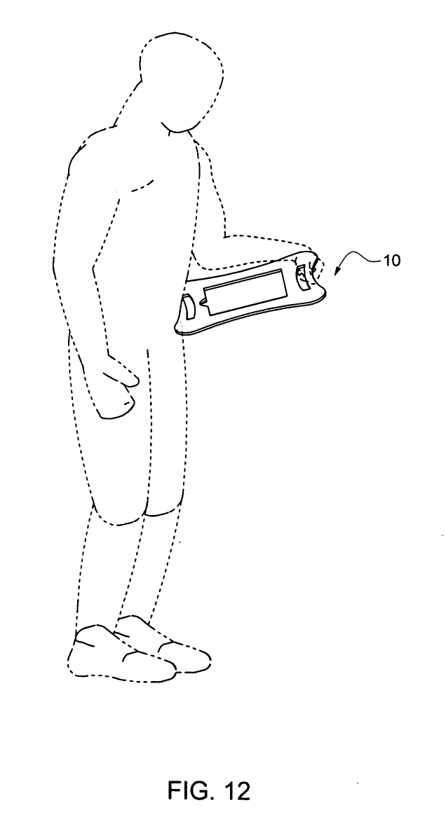

In FIG. 12, the primary user holds the holder with the fingers of his or her left hand grasping the right finger hole from the top, wrapping around the side of the holder and extending through the right finger hole from the bottom. The left side of the holder is held against the midsection, where the concavity and lobes keep it stable and secure.

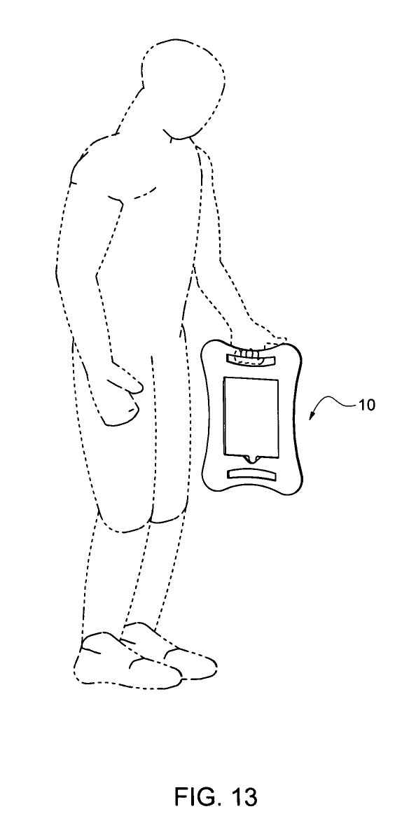

In FIG. 13, the primary user holds one end of the holder with one hand in a carry position so that the holder is suspended like an attaché case.

FIGS. 8-13 show only the primary user, but it will be understood that various other positions may be used when a secondary user is also involved. If a work surface such as a table or bench is convenient, they will probably place the holder on the work surface and use the handles for positioning the holder in the desired translational and rotational position on it. They may either view the computer in a single position on the work surface, or pass it between them on the surface. If they are standing, the primary user may simply use a grip shown in FIG. 8 or 13, rotate the holder upward to a level position, and allow the secondary user to steady the holder by grasping the right hand elongated slot. Or the primary user may simply use the handles to pass the holder to the secondary user completely.

The position shown in FIG. 8 is the basic position for sharing situations when there is no work surface involved. Typically the primary user will use this position when offering to share, orally or by body language. The secondary user may then use the available handle to steady the holder, and in the process will probably rotate it so that the computer display screen is at a good viewing angle. The two may use their free hands to point to things on the screen or touch the screen to activate it, while conversing. When they are through, the secondary user will let go of the handle and the primary user may grip it, as shown in FIG. 9. The positions shown in FIGS. 10 and 11 can be useful when the primary user needs to have his free hand available to perform a task. The position shown in FIG. 12 can be useful if the primary user is reading aloud from the computer, as for example to a group.

The actual dimensions of the panel shown and described herein are as follows. The maximum distance (lobe edge to lobe edge) between the short sides is 15.5 in. The maximum distance (lobe edge to lobe edge) between the long sides is 11.0 in. The distance between (i) the midpoint of a straight line tangent to any two adjacent lobes and (ii) the midpoint of the corresponding side of the panel is 0.875 in. The panel thickness is 0.125 in. Each elongated slot has a width (parallel to long sides) of 0.6875 in., a length of 4.875 inches, and an area of 3.35 in².

Panel 12 may be made from a polyethylene-based organic plastic resin, such as HDPE. The product should be thin, light, strong and inexpensive. Other organic plastic resins will also be suitable. Preferably the resin selected will be recyclable.

When not in use, the inventive holder and attached computer may be conveniently and compactly stored in a central location in a suitable rack. An example of such a rack is a rectangular frame having corresponding, facing internal slots in two opposite sides for receiving the lobed ends of the panel. The slots can be either vertical, horizontal, or at an angle somewhere in between. The slots should be wide enough to allow the handles of the holder to slide freely in and out and spaced so that there is room for the computers to be spaced at least ⅛ inch from each other. Alternatively, the holders can be hung on a fixture such as a nail or hook. For this purpose holes, or punch indentations for drilling any holes that may be desired, could be provided in the lobes.

I have mentioned storage in this detail in order to illustrate the use of the invention like a clipboard. In the fitness program application mentioned above, for example, there could be one tablet computer and holder for each client. These would be stored in a central location when not in use, and be readily accessible by individual members of the staff as appropriate.

The thickness of the panel can be decreased, but at some point there will be a tradeoff of undue flexibility (bending), material selection, and cost. Increasing it may introduce considerations of bulkiness, weight, and storage space. I believe that making it thicker than 0.5 inches would probably not serve a useful purpose. It should be noted that attachment of the holder to the computer will reinforce it structurally and will reduce bending considerably.

The area of an elongated slot should be at least 0.5 in² in order to be sufficiently large to accept four fingers of a typical user. Making the slot too large would reduce rigidity of the holder and computer.

It will be understood that, while presently preferred embodiments of the invention have been illustrated and described, the invention is not limited thereto, but may be otherwise variously embodied within the scope of the following claims.

1. A holder attachable to a tablet computer, which holder may be grasped and held by a user and comprises
(a) a substantially flat, generally rectangular, frame-like panel having four sides, the distance between the two short opposite sides being greater than the distance between the two long opposite sides;
(b) a central opening in the panel through which the screen of the computer is viewable; and
(c) two opposing outboard portions, each of which is between the central opening and a shorter side and will extend outward of the computer;
(d) each outboard portion having an elongated slot which is near, and generally parallel to, the outward edge of that outboard portion, the slot and edge defining a flat handle between them, and the slot being sized and shaped to receive four fingers of the user.

2. A holder according to claim 1 wherein the maximum thickness of the panel is less than 0.5 in.

3. A holder according to claim 1 wherein the thickness of the panel is approximately 0.125 in.

4. A holder according to claim 1 wherein each slot has an area greater than 0.5 in².

5. A holder according to claim 1 wherein the outward edge of each outboard portion is concave at its center and over a major portion of its length, so that the shape of the edge fits the shape of the midsection of the body of a typical user.

6. A holder according to claim 5 wherein each longer opposite side is concave at its center and over a major portion of its length, so that the shape of the edge fits the shape of the midsection of the body of a typical user.

7. A holder according to claim 6 wherein each of the four intersections of adjacent sides form convex lobes.

8. A holder according to claim 1 wherein the top edges of the panel are chamfered or radiused.

9. In combination, a holder according to claim 1 and a tablet computer, wherein the top of the tablet computer is attached to the bottom of the holder so that the display screen of the tablet computer is fully viewable and accessible through the opening in the holder and the outboard portions of the holder extend outward of the computer.

10. The combination of claim 9, wherein the attachment is effected by gluing.

11. The combination of claim 9 which has a maximum thickness of 0.5 in.

12. The combination of claim 9, wherein, when the user grips only one handle with only one hand, with his or her fingers passing around the outside edge of the handle, hooking under it, and passing upward through the slot, similar to a natural grip on a steering wheel, he or she can comfortably hold and control the assembly when the assembly is oriented with its long sides extending horizontally away from that hand.

13. In combination, a holder according to claim 1, a tablet computer, and a thin plastic clamshell enclosure for the tablet computer, wherein the top of the tablet computer is attached to the bottom surface of the top of the clamshell enclosure, and the top surface of the top of the clamshell enclosure is attached to the bottom of the holder, so that the display screen of the tablet computer is fully viewable and accessible through the opening in the holder and the outboard portions of the holder extend outward of the computer.

14. The combination of claim 13, wherein the attachments are effected by gluing.

15. The combination of claim 13 which has a maximum thickness of 0.5 in.

16. The combination of claim 13, wherein, when the user grips only one handle with only one hand, with his or her fingers passing around the outside edge of the handle, hooking under it, and passing upward through the slot, similar to a natural grip on a steering wheel, he or she can comfortably hold and control the assembly when the assembly is oriented with its long sides extending horizontally away from that hand.

17. A method of using a combination according to claim 9 in which a primary user, who is the owner or custodian of the tablet computer and its contents, wishes to physically share the information with a secondary user by allowing him to view the screen, input information to the computer, or manipulate the computer to get information out of it, in which method
the primary user grasps and holds the holder with only one hand, with the fingers passing around the outside edge of the handle, hooking under it, and passing upward through the slot, and with the thumb bearing on the top surface of the panel either on the handle or on an adjacent lobe, in order to resist the tendency gravity to rotate the holder downward about the axis of the handle;
the primary user offers to share the information or the operation of the computer; and
the secondary user grasps the available handle to steady the combination and rotate it so that the computer display screen is at a good viewing angle.
